(19) United States
(12) Patent Application Publication
(10) Pub. No.: US 2024/0164871 A1
(43) Pub. Date: May 23, 2024

(54) ELASTIC ORTHODONTIC APPLIANCE

(71) Applicants: Won MOON, Los Angeles, CA (US); Ehab ABDELBAR, Los Angeles, CA (US); Paul KIM, Diamond Bar, CA (US)

(72) Inventors: Won MOON, Los Angeles, CA (US); Ehab ABDELBAR, Los Angeles, CA (US); Paul KIM, Diamond Bar, CA (US)

(21) Appl. No.: 18/423,192

(22) Filed: Jan. 25, 2024

Related U.S. Application Data
(63) Continuation-in-part of application No. 15/914,932, filed on Mar. 7, 2018, now abandoned.
(60) Provisional application No. 62/624,281, filed on Jan. 31, 2018.

(51) Int. Cl. A61C 7/08

(52) U.S. Cl. CPC A61C 7/08; A61C 2201/00

(57) ABSTRACT

Provided herein is an orthodontic aligning appliance for moving tooth or teeth of a patient and methods of making and using the same.

### CROSS-REFERENCE TO RELATED APPLICATIONS

This application is a continuation-in-part of U.S. patent application Ser. No. 15/914,932, filed on Mar. 7, 2018, which claims the benefit of U.S. Provisional Patent Application 62/624,281, filed on Jan. 31, 2018, the teachings of which are incorporated herein by reference in their entirety.

### FIELD OF THE INVENTION

The present disclosure generally relates to an orthodontic aligning appliance and methods of making and using the same.

### BACKGROUND OF THE INVENTION

Orthodontic tooth movement is accomplished by applying force to a tooth or set of teeth. This force causes a biological remodeling of the bone surrounding the teeth. This remodeling causes the tooth to shift and move inside the jaw bones. This orthodontic force can be applied by fixed and/or removable appliances. One type of appliances that is gaining popularity is orthodontic aligners or clear aligners. Clear aligners are a type of removable appliances used to move the teeth by having the patient wear the said aligner for 1-2 weeks and then switching to another sequential tray where they wear it for 1-2 weeks and so on and so forth.

Clear aligners are fabricated by thermoforming a heat sensitive clear plastic sheet onto a dental model of the teeth. In the aforementioned dental model, the teeth are shifted by a small increment in position and orientation. The concept is that when the patient wears the plastic trays they will flex and distort and apply force to the teeth forcing them into a new position similar to the dental model used to fabricate the tray. The process is repeated for the number of trays needed to place the teeth in an ideal position.

There are a few inherent problems with plastic aligners. The current plastic tooth re-alignment technologies using clear aligners exert intermittent aligning forces, and thus, requires at least several trays, and often times more than a dozen trays, and lengthy treatment time (about 2 years) to re-align the teeth to a desired position, resulting in waste of tray materials and onerous doctor visit times so as to make the technology un-economical and sometimes cost prohibitive. Moreover, clear Aligners have a limited range of flexing before they are permanently deformed and hence they can only move the teeth by a small increment at a time. If a large incremental movement is attempted, then usually two things will occur, which are either: 1) aligners will lose track of the teeth and will not move them into the proposed position or orientation, or 2) the aligner will distort beyond plastic deformation and will be permanently deformed and might not fit into the patient's mouth all together. Additionally, the nature of the material used in the aligner dictates the amount of force applied on the teeth and the rate at which the said force is dissipated. The plastic used in aligners applies a large amount of force initially and then it dissipates quickly. This is mainly due to the low flexibility of the material.

Further, the aforementioned force loading and dissipation is not biologically favorable in efficient tooth movement because it is considered a large intermittent force loading where teeth move faster and respond better to small continuous forces.

Therefore, there is a need for aligners that overcome the aforementioned short-comings of the clear aligner.

Therefore, the embodiments described below address the above-identified issues and needs.

Because Aligners have a uniform thickness on the occlusal surface of the teeth. This can cause the posterior teeth to get imbedded inside the jaw bone (Intrusion movement). This is a general side effect of aligners that is usually very apparent with longer treatment times.

### SUMMARY OF THE INVENTION

In one aspect of the present disclosure, it is provided an orthodontic appliance formed of a homogeneous composition comprising an elastic material and a reinforcing material, the appliance exerting a continuous aligning force on a tooth or teeth along a dental arch,
wherein the reinforcing material is a particulate material,
wherein the orthodontic appliance comprises tooth sockets that correspond to and enclose each tooth on the dental arch,
wherein the elastic material has an elasticity such that it is capable of being stretched at least 300% of its original length.

In some embodiments, the elastic material is a material other than polyester, and wherein the elastic material accounts for all or substantially all the elastic properties of the appliance.

In some embodiments, the orthodontic appliance covers the entire surface of each tooth of the dental arch; covering and being configured for being in direct contact with the gum surface of each tooth; and covering and being configured for being in direct contact with the entire palatial surface or the entire sublingual surface of oral cavity.

In some embodiments of the disclosed appliance, optionally in combination with any or all the various embodiments disclosed herein, the elastic material comprises at least 10 wt % of the appliance forming material.

In some embodiments of the disclosed appliance, optionally in combination with any or all the various embodiments disclosed herein, the elastic material comprises at least 20 wt % of the appliance forming material.

In some embodiments of the disclosed appliance, optionally in combination with any or all the various embodiments disclosed herein, the elastic material comprises at least 30 wt % of the appliance forming material.

In some embodiments of the disclosed appliance, optionally in combination with any or all the various embodiments disclosed herein, the elastic material comprises at least 40 wt % of the appliance forming material.

In some embodiments of the disclosed appliance, optionally in combination with any or all the various embodiments disclosed herein, the elastic material comprises at least 50 wt % of the appliance forming material.

In some embodiments of the disclosed appliance, optionally in combination with any or all the various embodiments disclosed herein, the elastic material comprises at least 60 wt % of the appliance forming material.

In some embodiments of the disclosed appliance, optionally in combination with any or all the various embodiments disclosed herein, the elastic material comprises at least 70 wt % of the appliance forming material.

In some embodiments of the disclosed appliance, optionally in combination with any or all the various embodiments disclosed herein, the elastic material comprises at least 80 wt % of the appliance forming material.

In some embodiments of the disclosed appliance, optionally in combination with any or all the various embodiments disclosed herein, the elastic material comprises at least 90 wt % of the appliance forming material.

In some embodiments of the disclosed appliance, optionally in combination with any or all the various embodiments disclosed herein, the elastic material comprises at least 95 wt % of the appliance forming material.

In some embodiments of the disclosed appliance, optionally in combination with any or all the various embodiments disclosed herein, the elastic material comprises between 0-100%. e.g. 0<x<100, where x is the elasticity.

In some embodiments of the disclosed appliance, optionally in combination with any or all the various embodiments disclosed herein, the elastic material has an elasticity that it is capable of being stretched at least 300% of its original length.

In some embodiments of the disclosed appliance, optionally in combination with any or all the various embodiments disclosed herein, the elastic material is selected from the group consisting of silicone or orthodontic power chain material, and orthodontic rubber bands.

In some embodiments of the disclosed appliance, optionally in combination with any or all the various embodiments disclosed herein, the appliance forming material further comprises a reinforcing material to enhance stability and anchorage of the appliance.

In a second aspect of the present disclosure, it is provided a method of forming an orthodontic appliance, comprising:
creating a dental model of a patient tooth and bite,
constructing individual teeth from the dental model,
moving a tooth or teeth of target of alignment according to a prescription by a treating doctor to create an aligned dental model of the patient,
forming at least one appliance from the aligned dental model of the patient, and
wherein the appliance orthodontic appliance is formed of a homogeneous composition comprising an elastic material and a reinforcing material, the appliance exerting a continuous aligning force on a tooth or teeth along a dental arch,
wherein the reinforcing material is a particulate material,
wherein the orthodontic appliance comprises tooth sockets that correspond to and enclose each tooth on the dental arch,
wherein the elastic material has an elasticity such that it is capable of being stretched at least 300% of its original length.

In some embodiments, the elastic material is a material other than polyester, and wherein the elastic material accounts for all or substantially all the elastic properties of the appliance.

In some embodiments, the orthodontic appliance covers the entire surface of each tooth of the dental arch; covering and being configured for being in direct contact with the gum surface of each tooth; and covering and being configured for being in direct contact with the entire palatial surface or the entire sublingual surface of oral cavity.

In some embodiments of the disclosed method, optionally in combination with any or all the various embodiments disclosed herein, moving a tooth or teeth of target comprises moving the tooth or teeth of target manually or using computer software.

In some embodiments of the disclosed method, optionally in combination with any or all the various embodiments disclosed herein, forming an appliance comprises forming the appliance by direct 3D printing (Additive manufacturing), CNC Machining (Subtractive manufacturing) or by casting.

In some embodiments of the disclosed method, optionally in combination with any or all the various embodiments disclosed herein, forming the appliance by casting comprises:
3D printing a cast-able appliance using a cast-able material, fabricating a mold from the cast-able appliance, and
injecting into the mold the appliance forming material to form the appliance.

In some embodiments of the disclosed method, optionally in combination with any or all the various embodiments disclosed herein, the appliance forming material comprises a reinforcing material to enhance appliance stability, anchorage, and force loading.

In a third aspect of the present disclosure, it is provided a method of aligning a tooth or teeth of target of a patient, comprising:
forming an appliance, and
applying the appliance to the patient to move the tooth or teeth of target from an original position(s) to a prescribed position(s) according to a prescription by a treating doctor,
wherein forming the appliance comprises:
   creating a dental model of a patient tooth and bite,
   constructing individual teeth from the dental model,
   moving a tooth or teeth of target of alignment according to a prescription by a treating doctor to create an aligned dental model of the patient,
forming at least one appliance from the aligned dental model of the patient,
wherein the appliance is formed of a homogeneous composition comprising an elastic material and a reinforcing material, the appliance exerting a continuous aligning force on a tooth or teeth along a dental arch,
wherein the reinforcing material is a particulate material,
wherein the orthodontic appliance comprises tooth sockets that correspond to and enclose each tooth on the dental arch,
wherein the elastic material has an elasticity such that it is capable of being stretched at least 300% of its original length.

In some embodiments, the elastic material is a material other than polyester, and wherein the elastic material accounts for all or substantially all the elastic properties of the appliance.

In some embodiments, the orthodontic appliance covers the entire surface of each tooth of the dental arch; covering and being configured for being in direct contact with the gum surface of each tooth; and covering and being configured for being in direct contact with the entire palatial surface or the entire sublingual surface of oral cavity.

In some embodiments of the disclosed method, optionally in combination with any or all the various embodiments disclosed herein, the appliance is according to any of the various embodiments disclosed herein.

In some embodiments of the disclosed method, optionally in combination with any or all the various embodiments disclosed herein, the prescribed position is an intermediate position toward a final prescribed alignment of the tooth or teeth of target of alignment prescribed by a treating doctor.

In a further aspect of the present disclosure, it is provided an orthodontic aligner kit, comprising at least one appliance according to the various embodiments disclosed herein. In some embodiments of the disclosed aligner kit, optionally in combination with any or all the various embodiments disclosed herein, the aligner comprises a plurality of appliances, wherein each appliance is formed by a method according to the various embodiments of the method disclosed herein.

### DESCRIPTION OF THE DRAWINGS

FIG. 1 is an image of an embodiment of the disclosed appliance showing a view of the top side (non-tooth contacting side) of the disclosed appliance.

FIG. 2 is an image of an embodiment of the disclosed appliance showing a view of the bottom side (tooth/teeth contacting side) of the disclosed appliance.

FIG. 3 shows an image of an embodiment of the disclosed appliance (top) being applied to teeth (bottom).

FIGS. 4A-4D show one aspect of the disclosed appliance over traditional aligner appliances.

### DETAILED DESCRIPTION OF THE INVENTION

### Definitions

As used herein, the term “original position” of tooth or teeth refers to the position of the tooth or teeth of the target of treatment prior to the treatment using the appliance disclosed herein; and the term “final position” refers to position of such tooth or teeth at the conclusion time point of an orthodontic treatment course prescribed by a treating doctor; and the term “intermediate position” refers to any position between the original position and the final position of the tooth or teeth of the target of treatment prescribed by a treating doctor.

As used herein, the term “appliance” or “aligner”, which is used interchangeably herein, refers to an orthodontic device for moving a tooth or teeth according to a prescription by a treating doctor. Clear orthodontic appliances refer to those made from a plastic material, which is generally a polyester material. Such clear appliances are exemplified by Invisalign™ aligners. The Invisalign™ aligners, and methods of making and using the same, are described in general in U.S. Pat. Nos. 6,450,807, and 5,975,893, the teaching of which is incorporated herein by reference in its entirety.

As used herein, the term “homogeneous composition” refers to a composition disclosed herein that is consistent in its composition of components in the entirety of a appliance or tray that is formed from the composition. Additionally, a homogeneous composition disclosed herein has a size that is capable of being 3D-printed so as to make a device or a tray made by 3D-printing has a structure that is consistent in composition in the entirety of the appliance or tray. More specifically, to be 3D-printable, a size of the particle, if any, must be less than 100 microns, preferably from 1 nm to about 20 micron or from 10 nm to 10 micron or 10 nm to about 10 micron or from 10 nm to about 1 micron or from 100 nm to about 1 micron.

As used herein, the term “elastic appliance” refers to an orthodontic appliance capable of being stretched to a substantially higher degree than traditional polymer based clear aligners, such as the Invisalign™ aligners.

As used herein, the term “intermittent aligning force” refers to an aligning force generated by an aligner that substantially or entirely loses its strength due to characteristics of the material forming the aligner, e.g., due to fatigue, aging, degradation, erosion, or breaking down of the material. In contrast, “continuous aligning force” refers to an aligning force that is not intermittent, e.g., the aligning force generated by conventional plastic orthodontic aligners such as the Invisalign™ aligners.

### Orthodontic Appliances

In one aspect of the present disclosure, it is provided an orthodontic appliance formed of a homogeneous composition comprising an elastic material and a reinforcing material, the appliance exerting a continuous aligning force on a tooth or teeth along a dental arch,
wherein the reinforcing material is a particulate material,
wherein the orthodontic appliance comprises tooth sockets that correspond to and enclose each tooth on the dental arch,
wherein the elastic material has an elasticity such that it is capable of being stretched at least 300% of its original length.

In some embodiments, the elastic material is a material other than polyester, and wherein the elastic material accounts for all or substantially all the elastic properties of the appliance.

In some embodiments, the orthodontic appliance covers the entire surface of each tooth of the dental arch; covering and being configured for being in direct contact with the gum surface of each tooth; and covering and being configured for being in direct contact with the entire palatial surface or the entire sublingual surface of oral cavity.

In some embodiments of the disclosed appliance, optionally in combination with any or all the various embodiments disclosed herein, the elastic material comprises at least 10 wt % of the appliance forming material.

In some embodiments of the disclosed appliance, optionally in combination with any or all the various embodiments disclosed herein, the elastic material comprises at least 20 wt % of the appliance forming material.

In some embodiments of the disclosed appliance, optionally in combination with any or all the various embodiments disclosed herein, the elastic material comprises at least 50 wt % of the appliance forming material.

In some embodiments of the disclosed appliance, optionally in combination with any or all the various embodiments disclosed herein, the elastic material comprises at least 80 wt % of the appliance forming material.

In some embodiments of the disclosed appliance, optionally in combination with any or all the various embodiments disclosed herein, the elastic material comprises at least 90 wt % of the appliance forming material.

In some embodiments of the disclosed appliance, optionally in combination with any or all the various embodiments disclosed herein, the elastic material comprises at least 95 wt % of the appliance forming material.

In some embodiments of the disclosed appliance, optionally in combination with any or all the various embodiments disclosed herein, the elastic material has an elasticity that it is capable of being stretched at least 300% of its original length.

In some embodiments of the disclosed appliance, optionally in combination with any or all the various embodiments disclosed herein, the elastic material is selected from the group consisting of silicone or power chain material, and orthodontic rubber bands.

In some embodiments of the disclosed appliance, optionally in combination with any or all the various embodiments disclosed herein, the appliance forming material further comprises a reinforcing material to enhance stability and anchorage of the appliance.

### Appliance Forming Materials

Appliance forming materials usable for forming the elastic appliance disclosed herein can be any biocompatible elastic materials. As used herein, the term “elastic material” generally refers to materials which possess high elasticity (i.e.) which can be stretched several times its original length (at least 300%) and upon releasing of the stress (stretching force), it returns back to its original shape and dimensions.

Examples of elastic materials useful in the present disclosure include elastomers, which are the class of polymer materials with high elastic nature. Elastomers show entropy-dependent elasticity. The polymer chains return back to the original state because it prefers to be in the lowest state of entropy. Elastomers are the class of polymer materials with high elastic nature and they include natural rubber, synthetic rubber, nitrile rubber, silicone rubber, urethane rubbers, chloroprene rubber, Ethylene Vinyl Acetate (EVA rubber), ethylene propylene diene monomer (M-class) rubber (EPDM), styrene-butadiene rubber (SBR), etc.

The appliance forming materials can be substantially all elastic materials or, in some embodiments, can include other materials, such as a reinforcing material. In some embodiments, the appliance forming material specifically exclude a polyester material.

As used herein, the term “reinforcing material” refers to any material capable of enhancing appliance stability, anchorage, and force loading. To enhance stability of an orthodontic appliance, such reinforcing material imparts attributes to the appliance that inhibits or prevents degradation or erosion of the appliance such that the appliance retains its elasticity and aligning force over the entire course of treatment or, alternatively, over a period of 2 weeks, 4 weeks, 6 weeks, 8 weeks, 12 weeks, 16 weeks, 20 weeks, 24 weeks, 26 weeks or 28 weeks, retaining at least 80% (e.g., about 85%, 90%, 95%, 98%, or about 99%) of its elasticity and/or aligning force.

To enhance anchorage of an orthodontic appliance, such reinforcing material imparts, for example, attributes that allows the appliance to be anchored at a point or an area in the oral cavity. Such attributes can be, for example, adhesion, and thus, a reinforcing material that enhances adhesion of the appliance would be useful.

Examples of such reinforcing materials can include a fiber material, which fiber material can be, for example, polyester fibers, or polyethylene fibers.

Another example of such reinforcing material is metallic alloys used in orthodontics or dentistry in general (ST. steel, NiTi, TMA, Cu—NiTi).

The physical properties of the elastic material (modulus of elasticity, stiffness, etc.) can be readily modified according to the type of orthodontic movement needed with any specific case.

The appliance disclosed herein of elastic material will have the shape of individual teeth so that it fits around individual teeth. Using the analogy of glover-fingers, the appliance disclosed herein fits around individual teeth like a glove fits individual fingers, and using the same analogy, previous art plastic aligners cover teeth like a mitten covers the fingers where all the fingers are wrapped around with no internal boundary. The disclosed appliance covers individual teeth and wrap around them to eliminate the tracking error problem of prior art.

In some embodiments, the internal dimensions of the elastic appliance can have the same size of the teeth to provide perfect fit or they can be designed to be slightly smaller, which is made possible due to the elasticity of the elastic appliance forming material. The combination of smaller size and elastic material will entail that the aligner will be slightly stretched and hence provide a better grip on individual teeth.

In some embodiments, the appliance disclosed herein can have very thin or no coverage in areas where upper and lower teeth interact or touch. This will eliminate the intrusion side effect mentioned earlier in the prior art.

In some further embodiments, the elastic appliance disclosed herein can have variable thickness either before fitting into the patient mouth or due to variable stretching that will happen after fitting into the patient mouth.

An advantage of the disclosed appliance is that it can be made to exert a relatively lighter force that will span for a longer time period before dissipating and another activation is needed.

This provided a more biologically compatible and favorable force loading leading to more efficient and comfortable tooth movement.

### Aligner Kit

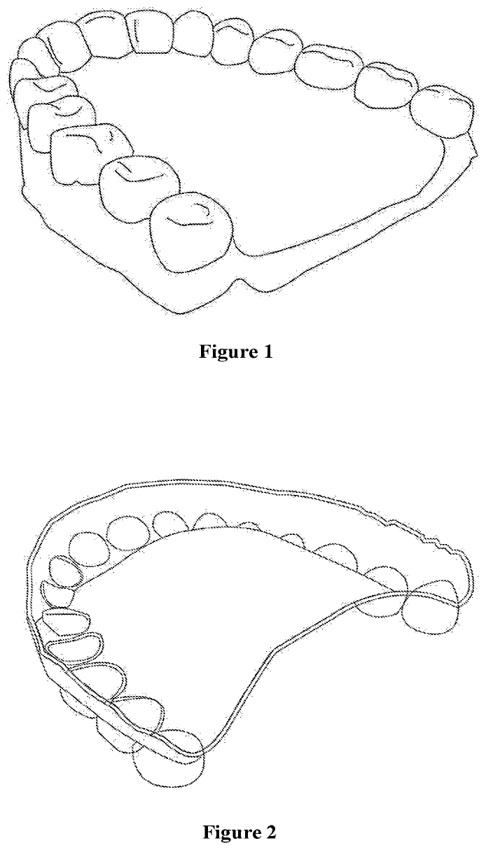

FIG. 1 shows an image of an embodiment of the disclosed appliance showing a view of the top side (non-tooth contacting side) of the disclosed appliance. FIG. 2 is an image of an embodiment of the disclosed appliance showing a view of the bottom side (tooth/teeth contacting side) of the disclosed appliance.

In a further aspect of the present disclosure, it is provided an orthodontic aligner kit, comprising at least one appliance according to the various embodiments disclosed herein. In some embodiments of the disclosed aligner kit, optionally in combination with any or all the various embodiments disclosed herein, the aligner comprises a plurality of appliances, wherein each appliance is formed by a method according to the various embodiments of method disclosed herein.

In some embodiments of the disclosed aligner kit, optionally in combination with any or all the various embodiments disclosed herein, the plurality of appliances have up to three appliances.

### Method of Fabrication

In a second aspect of the present disclosure, it is provided a method of forming an orthodontic appliance, comprising:
creating a dental model of a patient tooth and bite,
constructing individual teeth from the dental model,
moving a tooth or teeth of target of alignment according to a prescription by a treating doctor to create an aligned dental model of the patient,
forming at least one appliance from the aligned dental model of the patient,
wherein the appliance is formed of a homogeneous composition comprising an elastic material and a reinforcing material, the appliance exerting a continuous aligning force on a tooth or teeth along a dental arch,
wherein the reinforcing material is a particulate material,
wherein the orthodontic appliance comprises tooth sockets that correspond to and enclose each tooth on the dental arch,
wherein the elastic material has an elasticity such that it is capable of being stretched at least 300% of its original length.

In some embodiments, the elastic material is a material other than polyester, and wherein the elastic material accounts for all or substantially all the elastic properties of the appliance.

In some embodiments, the orthodontic appliance covers the entire surface of each tooth of the dental arch; covering and being configured for being in direct contact with the gum surface of each tooth; and covering and being configured for being in direct contact with the entire palatial surface or the entire sublingual surface of oral cavity.

In some embodiments of the disclosed method, optionally in combination with any or all the various embodiments disclosed herein, moving a tooth or teeth of target comprises moving the tooth or teeth of target manually or using computer software.

In some embodiments of the disclosed method, optionally in combination with any or all the various embodiments disclosed herein, forming an appliance comprises forming the appliance by direct 3D printing or by casting.

In some embodiments of the disclosed method, optionally in combination with any or all the various embodiments disclosed herein, forming the appliance by casting comprises:
3D printing a cast-able appliance using a cast-able material,
fabricating a mold from the cast-able appliance, and
injecting into the mold the appliance forming material to form the appliance.

In some embodiments of the disclosed method, optionally in combination with any or all the various embodiments disclosed herein, the appliance forming material comprises a reinforcing material to enhance appliance stability and anchorage.

3D-printing and casting are well documented methods of fabricating a 3D object.

In some embodiments of the disclosed method, optionally in combination with any or all the various embodiments disclosed herein, the elastic material comprises at least 10 wt % of the appliance forming material.

In some embodiments of the disclosed method, optionally in combination with any or all the various embodiments disclosed herein, the elastic material comprises at least 20 wt % of the appliance forming material.

In some embodiments of the disclosed method, optionally in combination with any or all the various embodiments disclosed herein, the elastic material comprises at least 50 wt % of the appliance forming material.

In some embodiments of the disclosed method, optionally in combination with any or all the various embodiments disclosed herein, the elastic material comprises at least 80 wt % of the appliance forming material.

In some embodiments of the disclosed method, optionally in combination with any or all the various embodiments disclosed herein, the elastic material comprises at least 90 wt % of the appliance forming material.

In some embodiments of the disclosed method, optionally in combination with any or all the various embodiments disclosed herein, the elastic material comprises at least 95 wt % of the appliance forming material.

In some embodiments of the disclosed method, optionally in combination with any or all the various embodiments disclosed herein, the elastic material has an elasticity that it is capable of being stretched at least 300% of its original length.

In some embodiments of the disclosed method, optionally in combination with any or all the various embodiments disclosed herein, the elastic material is selected from the group consisting of silicone or power chain material, and orthodontic rubber bands.

Methods of computer aided fabrication of orthodontic appliances are well documented in the art. Examples of such methods are described in U.S. Pat. Nos. 6,450,807 and 5,975,893, the teaching of which is incorporated herein by reference in its entirety.

### Method of Use

In a third aspect of the present disclosure, it is provided a method of aligning a tooth or teeth of target of a patient, comprising:
forming an appliance, and
applying the appliance to the patient to move the tooth or teeth of target from an original position(s) to a prescribed position(s) according to a prescription by a treating doctor,
wherein forming the appliance comprises:
   creating a dental model of a patient tooth and bite,
   constructing individual teeth from the dental model,
   moving a tooth or teeth of target of alignment according to a prescription by a treating doctor to create an aligned dental model of the patient,
forming at least one appliance from the aligned dental model of the patient, wherein the appliance is formed of a homogeneous composition comprising an elastic material and a reinforcing material, the appliance exerting a continuous aligning force on a tooth or teeth along a dental arch,
wherein the reinforcing material is a particulate material,
wherein the orthodontic appliance comprises tooth sockets that correspond to and enclose each tooth on the dental arch,
wherein the elastic material has an elasticity such that it is capable of being stretched at least 300% of its original length.

In some embodiments, the elastic material is a material other than polyester, and wherein the elastic material accounts for all or substantially all the elastic properties of the appliance.

In some embodiments, the orthodontic appliance covers the entire surface of each tooth of the dental arch; covering and being configured for being in direct contact with the gum surface of each tooth; and covering and being configured for being in direct contact with the entire palatial surface or the entire sublingual surface of oral cavity.

In some embodiments of the disclosed method, optionally in combination with any or all the various embodiments disclosed herein, the appliance is according to any of the various embodiments disclosed herein.

In some embodiments of the disclosed method, optionally in combination with any or all the various embodiments disclosed herein, the prescribed position is an intermediate position toward a final prescribed alignment of the tooth or teeth of target of alignment prescribed by a treating doctor.

In some embodiments of the disclosed method, optionally in combination with any or all the various embodiments disclosed herein, the elastic material comprises at least 10 wt % of the appliance forming material.

In some embodiments of the disclosed method, optionally in combination with any or all the various embodiments disclosed herein, the elastic material comprises at least 20 wt % of the appliance forming material.

In some embodiments of the disclosed method, optionally in combination with any or all the various embodiments disclosed herein, the elastic material comprises at least 50 wt % of the appliance forming material.

In some embodiments of the disclosed method, optionally in combination with any or all the various embodiments disclosed herein, the elastic material comprises at least 80 wt % of the appliance forming material.

In some embodiments of the disclosed method, optionally in combination with any or all the various embodiments disclosed herein, the elastic material comprises at least 90 wt % of the appliance forming material.

In some embodiments of the disclosed method, optionally in combination with any or all the various embodiments disclosed herein, the elastic material comprises at least 95 wt % of the appliance forming material.

In some embodiments of the disclosed method, optionally in combination with any or all the various embodiments disclosed herein, the elastic material has an elasticity that it is capable of being stretched at least 300% of its original length.

In some embodiments of the disclosed method, optionally in combination with any or all the various embodiments disclosed herein, the elastic material is selected from the group consisting of silicone or power chain material, and orthodontic rubber bands.

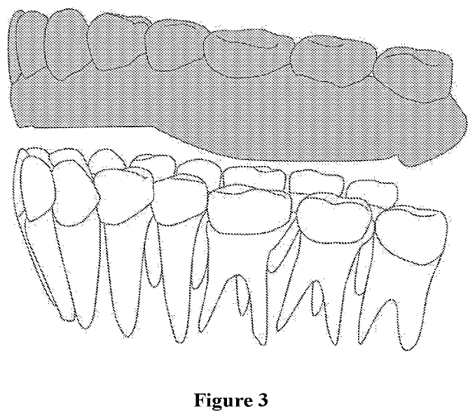

FIG. 3 shows an image of an embodiment of the disclosed appliance (top) being applied to teeth (bottom).

The following examples illustrate rather than limit the embodiments of the present disclosure.

### EXAMPLES

### Example 1. 3D-Printing Fabrication of Orthodontic Appliance

An elastic orthodontic appliance disclosed herein was fabricated by 3D-printing using an appliance forming material using the method disclosed herein. FIG. 1 shows an image of the appliance viewed from the non-tooth contacting side, and FIG. 2 shows an image of the appliance viewed from the tooth contacting side.

FIG. 3 shows an image of an embodiment of the disclosed appliance (top) being applied to teeth (bottom).

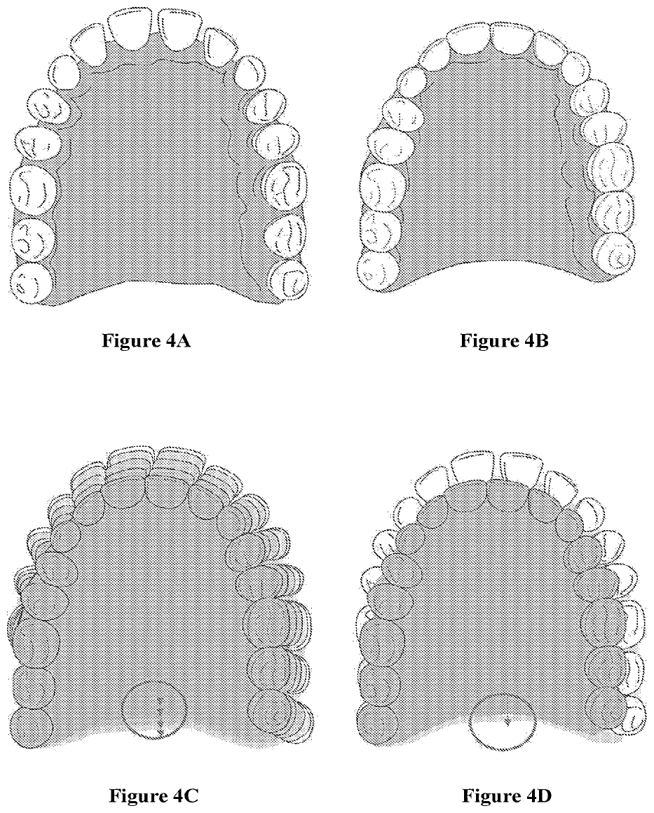

FIGS. 4A-4D show one aspect of the disclosed appliance over traditional aligner appliances in that the disclosed appliance significantly reduces the aligning steps in orthodontic treatment.

While various embodiments of the present disclosure have been shown and described herein, it will be obvious that such embodiments are provided by way of example only. Numerous variations, changes and substitutions may be made without departing from the disclosed subject matter herein. Accordingly, it is intended that the be limited only by the spirit and scope of the appended claims.

The teachings of the references, including patents and patent related documents, cited herein are incorporated herein in their entirety to the extent not inconsistent with the teachings herein.

We claim:

1. An orthodontic appliance formed of a homogeneous composition comprising an elastic material and a reinforcing material, the appliance exerting a continuous aligning force on a tooth or teeth along a dental arch,
wherein the reinforcing material is a particulate material,
wherein the orthodontic appliance comprises tooth sockets that correspond to and enclose each tooth on the dental arch, the orthodontic appliance covering the entire surface of each tooth of the dental arch; covering and being configured for being in direct contact with the gum surface of each tooth; and covering and being configured for being in direct contact with the entire palatial surface or the entire sublingual surface of oral cavity,
wherein the elastic material has an elasticity such that it is capable of being stretched at least 300% of its original length.

2. The orthodontic appliance according to claim 1, wherein the elastic material comprises at least 20 wt % of the combination of the elastic and reinforcing materials forming the appliance.

3. The orthodontic appliance according to claim 1, wherein the elastic material comprises at least 50 wt % of the combination of the elastic and reinforcing materials forming the appliance.

4. The orthodontic appliance according to claim 1, wherein the elastic material comprises at least 80 wt % of the combination of the elastic and reinforcing materials forming the appliance.

5. The orthodontic appliance according to claim 1, wherein the elastic material comprises at least 90 wt % of the combination of the elastic and reinforcing materials forming the appliance.

6. The orthodontic appliance according to claim 1, wherein the elastic material comprises at least 95 wt % of the combination of the elastic and reinforcing materials forming the appliance.

7. The orthodontic appliance according to claim 1, wherein the elastic material is a silicone rubber.

8. A method of aligning a tooth or teeth of target of a patient, comprising:
forming an appliance, and
applying the appliance to the patient to move the tooth or teeth of target from an original position(s) to a prescribed position(s) according to a prescription by a treating doctor,
wherein forming the appliance comprises:
creating a dental model of a patient tooth and bite, constructing individual teeth from the dental model,
moving a tooth or teeth of target of alignment according to a prescription by a treating doctor to create an aligned dental model of the patient, and
forming at least one appliance from the aligned dental model of the patient,
wherein the appliance is formed of a homogeneous composition comprising an elastic material and a reinforcing material, the appliance exerting a continuous aligning force on a tooth or teeth along a dental arch,
wherein the reinforcing material is a particulate material,
wherein the orthodontic appliance comprises tooth sockets that correspond to and enclose each tooth on the dental arch, the orthodontic appliance covering the entire surface of each tooth of the dental arch; covering and being configured for being in direct contact with the gum surface of each tooth; and covering and being configured for being in direct contact with the entire palatial surface or the entire sublingual surface of oral cavity,
wherein the elastic material has an elasticity such that it is capable of being stretched at least 300% of its original length.

9. An orthodontic aligner kit, comprising a plurality of appliances, the plurality of appliances being formed of a homogeneous composition comprising an elastic material and a reinforcing material, the appliance exerting a continuous aligning force on a tooth or teeth along a dental arch,
wherein the reinforcing material is a particulate material,
wherein the orthodontic appliance comprises tooth sockets that correspond to and enclose each tooth on the dental arch, the orthodontic appliance covering the entire surface of each tooth of the dental arch; covering and being configured for being in direct contact with the gum surface of each tooth; and covering and being configured for being in direct contact with the entire palatial surface or the entire sublingual surface of oral cavity,
wherein the elastic material has an elasticity such that it is capable of being stretched at least 300% of its original length.

10. The orthodontic aligner kit of claim 9, wherein the elastic material is a silicone rubber.

11. The orthodontic aligner kit of claim 9, wherein the elastic material comprises at least 20 wt % of the combination of the elastic and reinforcing materials forming the appliance.

12. The orthodontic aligner kit of claim 9, wherein the elastic material comprises at least 50 wt % of the combination of the elastic and reinforcing materials forming the appliance.

13. The orthodontic aligner kit of claim 9, wherein the elastic material comprises at least 80 wt % of the combination of the elastic and reinforcing materials forming the appliance.

14. The orthodontic aligner kit of claim 9, wherein the plurality of appliances has up to three appliances.
